(19) United States
(12) Patent Application Publication
(10) Pub. No.: US 2023/0390781 A1
(43) Pub. Date: Dec. 7, 2023

(54) SYSTEM FOR PROCESSING OF PADDY

(71) Applicant: AGRI PROCESS INNOVATIONS TECHNOLOGIES LLP, Bangalore (IN)

(72) Inventors: Shashikumar Thimmaiah, Bangalore (IN); Sridhar Nagalapur, Bangalore (IN)

(21) Appl. No.: 18/204,384

(22) Filed: May 31, 2023

(30) Foreign Application Priority Data
Jun. 2, 2022 (IN) 202241031581

(51) Int. Cl. B02B 5/02; A23L 7/196; B02B 7/00

(52) U.S. Cl. CPC B02B 5/02; A23L 7/1965; B02B 7/00

(57) ABSTRACT

A system (100) for processing of paddy comprises a set of processing stations, a set of field instruments (101), a local control unit (102), a cloud server (103) and remote control devices (104). Further the set of field instruments (101) are configured to collect data from set of processing stations monitor a processing station from the set of processing stations. Further the local control unit (102) comprises a processor coupled to a memory. Further, the processor is configured to execute a set of instructions for receiving the data from the set of field instruments (101). Further, the processor compares the data with pre-determined thresholds and generates set of commands corresponding to target field instrument. Based the comparison, the processor identifies the target processing station, corresponding to target field instrument, and transmitting the set of commands to the target processing station, thereby controlling the set of processing stations for paddy processing.

### CROSS-REFERENCE TO RELATED APPLICATIONS AND PRIORITY

The present application claims priority from the Indian patent application number 202241031581 filed on 2 Jun. 2022.

### TECHNICAL FIELD

The present subject matter described herein, in general, relates to a field of a food processing. More particularly, the present subject matter relates to a system and method for processing paddy.

### BACKGROUND

The concept of conversion of a paddy to a rice is known as the paddy processing. The paddy processing comprises a parboiling system and a super aging system. Further, the parboiling comprises three stages namely a pre hydration, a hydration and a gel cook station. Further the super-aging system comprises a gel cook process, a distribution process and a thermal seasoning process. The first stage of the pre hydration of a paddy is configured to receive raw paddy from a pre cleaning unit. In a conventional system, a batch wise pre hydration of the raw paddy is implemented which decreases the productivity of the paddy processing system. The batch wise processing of paddy also results in non-uniform quality between the batches. Further, the conventional system of the pre hydration does not ensure the uniform thermal treatment to each grain of the paddy. Further, non-optimum use of steam increases the operational cost in the conventional system of the pre-hydration. The conventional processing in rice milling industry includes a manual and/or a semi-automatic operation which result in batch wise or process wise inconsistency and non-uniform product quality.

Further, the conventional method is largely operator dependent and there is no control over the key process parameters such as time, temperature and pressure in the processing line.

At present, revolutionizing paddy processing demands more than equipment and mainly relies on detailed understanding of the science behind the processing as processing affects the physical, chemical, sensory and eating qualities of rice.

To overcome the existing challenges, digital tools mainly automation brings about better productivity, quality, energy efficiency, higher profits and decease in overall operational costs.

Thus, there is a long-standing need of a system for paddy processing which solves above mentioned problems.

### SUMMARY

This summary is provided to introduce the concepts related to a system for processing of paddy and the concepts are further described in the detail description. This summary is not intended to identify essential features of the claimed subject matter, nor it is intended to use in determining or limiting the scope of claimed subject matter.

In one embodiment a system for processing of paddy is disclosed, the system comprises, a set of processing stations; a set of field instruments. Further, one or more field instruments, from the set of field instruments may be configured to monitor a processing station from the set of processing stations. Further the set of field instruments may be configured to collect data from the set of processing stations. Further, the system comprises a local control unit. Furthermore, the local control unit comprises a processor coupled to a memory. Further the processor may be configured to execute a set of instructions stored in the memory for receiving the data from the set of field instruments. Further, the processor may be configured to execute a set of instructions stored in the memory for comparing the data with pre-determined thresholds and generates set of commands corresponding to at least one target field instrument, from the set of field instruments, based on the comparison. Further, the processor may be configured to execute a set of instructions stored in the memory for identifying at least one target processing station, from the set of processing stations, corresponding to at least one target field instrument, and transmitting the set of commands to at least one target processing station, thereby controlling the set of processing stations for paddy processing.

### BRIEF DESCRIPTION OF DRAWINGS

The detailed description is described with reference to the accompanying figures. In the Figures, the left-most digit(s) of a reference number identifies the Figure in which the reference number first appears. The same numbers are used throughout the drawings to refer like features and components.

FIG. 1 illustrates a network implementation of a system (100) for processing of paddy, in accordance with an embodiment of a present subject matter.

FIG. 2 illustrates a flowchart of operation performed at a local control unit (102) in accordance with an embodiment of a present subject matter.

FIG. 3 illustrates a flowchart of operation performed at a surge bin (200), in accordance with an embodiment of a present subject matter.

FIG. 4 illustrates a flowchart of operation performed at a pre-hydration station (300), in accordance with an embodiment of a present subject matter.

FIG. 5 illustrates a flowchart of operation performed at a hydration station (400), in accordance with an embodiment of a present subject matter.

FIG. 6 illustrates a flowchart of operation performed at a gel cook station (500), in accordance with an embodiment of a present subject matter.

FIG. 7 illustrates a drying station (600), in accordance with an embodiment of a present subject matter.

FIG. 8 illustrates a parboiling system (700), in accordance with an embodiment of a present subject matter.

FIG. 9 illustrates a super-aging system (800), in accordance with an embodiment of a present subject matter.

FIG. 10 illustrates set of field instruments (101-a to 101-h), in accordance with an embodiment of a present subject matter.

FIG. 11 illustrates set of field instruments (101-i to 101-o), in accordance with an embodiment of a present subject matter.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

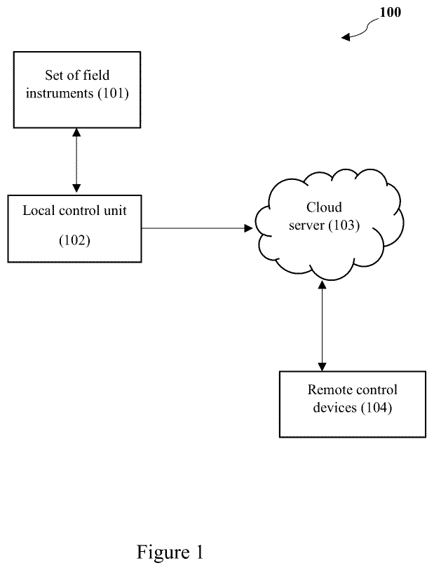

The present disclosure relates to a system (100) for processing of paddy. Now referring to FIG. 1, the system (100) for processing of paddy is illustrated, in accordance with the embodiment of the present subject matter. The system (100) for processing of paddy may comprise a set of processing stations, a set of field instruments (101), a local control unit (102), a cloud server (103) and remote control devices (104). Further at least one or more field instruments from the set of field instruments (101) are configured to monitor a processing station from the set of processing stations. Further, the set of field instruments (101) may be configured to collect data from the set of processing stations. Further, the local control unit (102) may comprise a processor coupled to a memory. Further, the processor from the local control unit (102) is configured to execute a set of instructions for receiving the data from the set of field instruments (101). The processor is further configured for comparing the data with pre-determined thresholds. The processor is further configured for generating set of commands corresponding to at least one target field instrument, from the set of field instruments (101), based the comparison. The processor is further configured for identifying at least one target processing station, from the set of processing stations, corresponding to the at least one target field instrument. Finally, the processor is further configured for transmitting the set of commands to the at least one target processing station, thereby controlling the set of processing stations for paddy processing.

In one embodiment the local control unit (102) may be a programmable logic controller (here onwards PLC). In one embodiment the set of processing stations may comprise a feeding elevator, a surge bin, a pre-hydration station, a hydration station, a gel cook station, a distribution box, thermal seasoning tanks and a drying station. In one embodiment the system (100) for processing of paddy may comprise a cloud server (103). Further the cloud server (103) may be configured to facilitate communication between the local control unit (102) and store data related to the paddy processing.

In another embodiment the local control unit (102) may comprise input/output cards or I/O cards configured to receive data and transmit instructions to the set of field instruments (101).

In another embodiment the system (100) for processing of paddy may comprise remote control devices (104) which are communicatively coupled with the cloud server (103). Further, the remote control devices (104) are configured to monitor and visualize the paddy processing from remote location.

In yet another embodiment the system (100) for processing of paddy may comprise industrial internet of things (here onwards IIoT) and may be linked to user. Further, the IIoT may facilitate communication between various remote control devices (104) thus making the processing of paddy fully automated and without any human intervention.

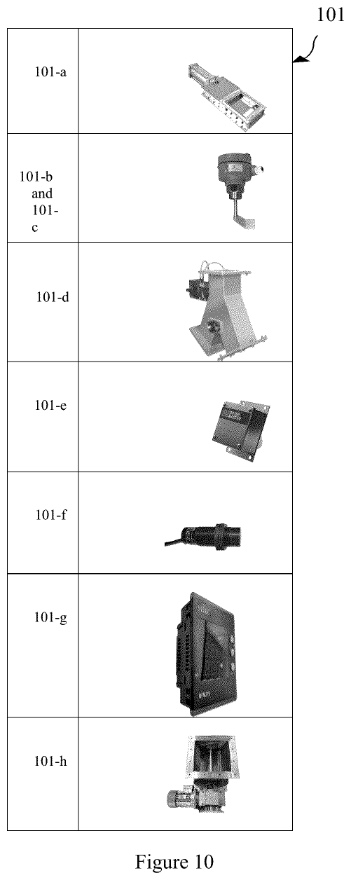

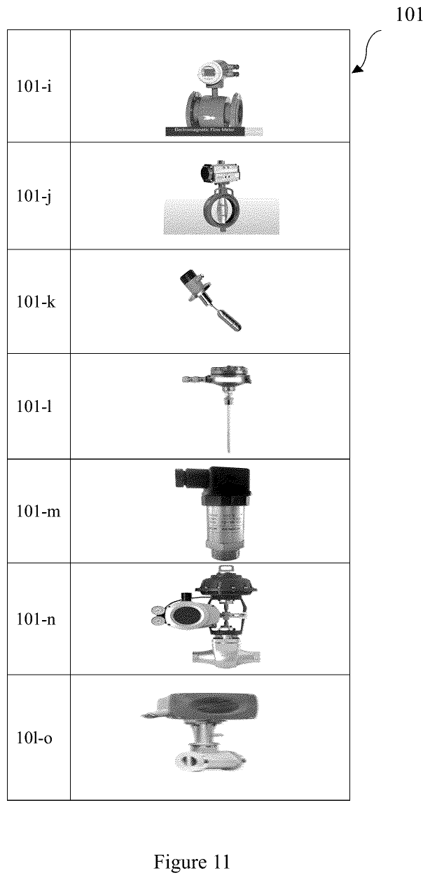

Now, in reference to FIGS. 10 and 11 a set of field instruments is disclosed. In one embodiment the set of field instruments (101) may comprise a pneumatic slide gate (101-a), a high level sensor (101-b), a low level sensor (101-c), a pneumatic diverter (101-d), a paddy moisture meter (101-e), a speed monitor (101-f), an energy meter (101-g), a rotary discharge system (101-h), a water flow meter (101-i), a pneumatic butterfly valve (101-j), a float level switch (101-k), a RTD temperature detector (101-l), a pressure transmitter (101-m), a pressure regulating valve (101-n) and a steam flow meter (101-o).

In one embodiment the pneumatic slide gate (101-a) may serve as intermediate discharges, or as cut off valves or as emergency shut off gates to stop material surges. The pneumatic slide gate is controlled by local control unit (102) of both air and electrical supply. The pneumatic slide gate (101-a) may get relay output from the local control unit (102) and may give digital feedback to local control unit (102).

In one embodiment the high level sensor (101-b) and low level sensor (101-c) may be used in dry bulk material application in surge bins for level measurement of food grains. When the unit senses the presence of material via the restricted rotation of the paddle, the reversing torque actuates the internal micro-switches and alarms the unit, to give corresponding output signal. The signals are received and controlled by the local control unit (102). The level sensors may get 230V AC supply for power on and may give 24V sensed feedback to the local control unit (102). In one embodiment, the pneumatic diverter (101-d) is enabled with Pneumatic diverter valves. The Pneumatic diverter valves are effective in routing materials along the required path with automated mechanism instead of the cumbersome manual process. This unit is connected to the local control unit (102). The pneumatic diverter (101-d) may get relay output from the local control unit (102) and may give digital feedback to local control unit (102).

In one embodiment, the paddy moisture meter (101-e) acts as an important control index in the grain processing. Real-time measurement of paddy moisture content is the prerequisite of the automatic control of all kinds of process applications to improve the drying quality and lower the energy consumption of the process. The paddy moisture meter (101-e) may get 24V DC supply for energizing and may give analog 4-20 ma feedback to the local control unit (102).

In one embodiment, the speed monitor (101-f) may be used as a flush mountable inductive sensor with integrated speed evaluation. The speed limit can be set via potentiometer and is integrated with the local control unit (102) for its operation. The speed monitor (101-f) gives digital feedback to the local control unit (102).

In one embodiment, the energy meter (101-g) acts as a multi-functional meter for energy monitoring with easy to install format. The key features include measurement of active and reactive energy, integrated LCD display which includes power, energy, current, and voltage measurements. The communication is achieved via RS-485.

In one embodiment, the rotary discharge system (101-h) may comprise a rotating type of monitor fixed with a discharge system. This unit may comprise of eight plates arranged to the central coupled gear box. The discharge of paddy from the rotary discharge gate is directly influenced by the equilibrium thermal temperature and is achieved once the grain attains the linear temperature acquisition. The rotary discharge system (101-h) may get relay output from the local control unit (102) and may give digital feedback to local control unit (102).

In one embodiment, the water flow meter (101-i) may be used for accurate measurement, control and monitoring of the water flow and to improve the efficiency of the system. The water flow meter (101-i) may get 230V AC supply for power ON and may give analog 4-20 ma feedback to the local control unit (102) and communicates using RS485.

In one embodiment, the pneumatic butterfly valve (101-j) may be used for regulating the flow of liquids. It can be remotely operated as the correcting unit of an automatic control system. Further, the pneumatic butterfly valve may use compressed air to operate the pneumatic actuator. The pneumatic butterfly valve (101-j) may give relay output from the local control unit (102) and may give digital feedback to local control unit (102).

In one embodiment, the float level switch (101-k) may be a compact and highly sensitive continuous level sensors featuring a micro switch, comprising a magnetic coupling float mechanism that rises and falls as liquid levels change. Further, the movement of the float creates a magnetic field that triggers the switch to open or close. The float level switch (101-k) may give 230V AC supply for power ON and feedback signals are monitored by the local control unit (102).

In one embodiment, the resistance temperature devices (here onwards RTD Temperature detector)—(101-l) may be used for measurement of temperature based on electrical resistance these devices generate accurate. Further, repeatable readings at temperatures up to 400° C., making them ideal tools for monitoring temperatures of the liquids.

In one embodiment, the pressure transmitter (101-m) may be used to measure pressure in liquids or gases. The pressure transmitter may have wide industrial application and serve as an indicator or alarm for the process. The pressure transmitter (101-m) may give 4-20 ma signal and may get analog 4-20 ma feedback to the local control unit (102).

In one embodiment, the pressure regulating valve (101-n) may be used to control the downstream pressure and may be used to maintain constant steam pressure onto the steam flowmeter, the control valve or directly onto process. The pressure regulating valve (101-n) may give 4-20 ma signal and may get analog 4-20 ma feedback to the local control unit (102).

In one embodiment, the steam flow meter (101-o) may be configured for measuring the mass of saturated and superheated steam and works on the principle of differential pressure and may be useful in evaluating the performance, efficiency and for regulation of steam required for a system. The steam flow meter (101-o) may give 24V DC supply for energizing and may get analog 4-20 ma feedback to the local control unit (102) along with RS485 communication.

In one embodiment, the belt slack monitor may be configured to measure the belt parameters in order to prevent spilling, down time and material waste and maintain the tension of the conveyor belt as per requirement of the process.

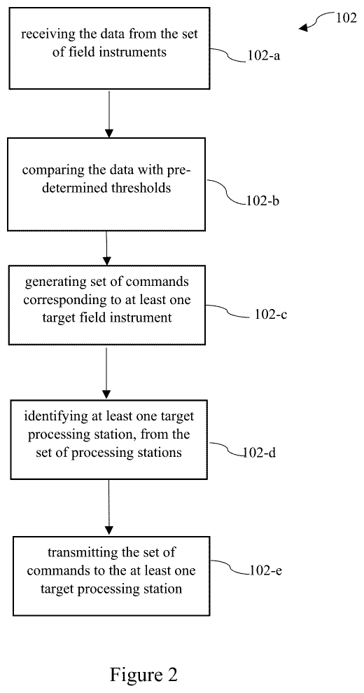

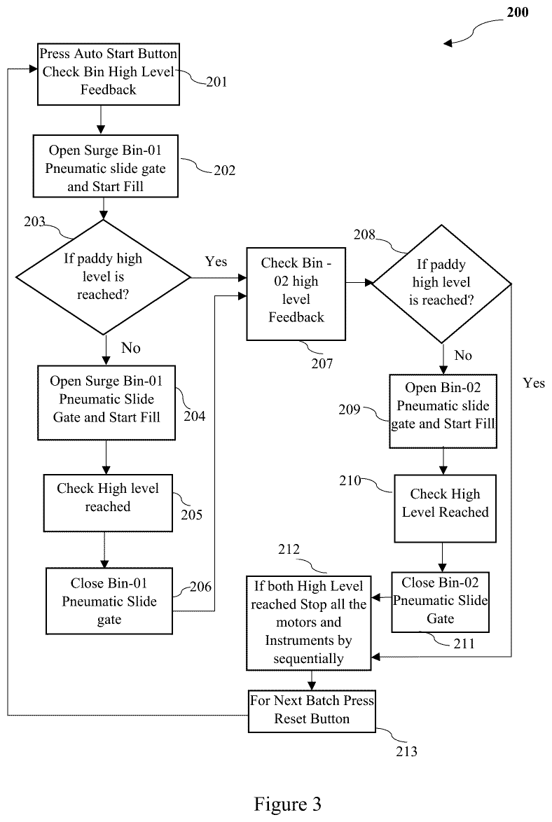

Now referring to FIG. 2, a flowchart of operation performed at a local control unit (102) is disclosed. The local control unit (102) may comprise a processor coupled to a memory. The said processor may be configured to execute a set of instructions stored in the memory for receiving (102-a) the data from the set of field instruments (101). Further, comparing (102-b) the data with pre-determined thresholds. Further, generating (102-c) set of commands corresponding to at least one target field instrument, from the set of field instruments (101), based the comparison. Further, identifying (102-d) at least one target processing station, from the set of processing stations, corresponding to the at least one target field instrument and finally transmitting (102-e) the set of commands to the at least one target processing station, thereby controlling the set of processing stations for paddy processing, Now referring to FIG. 3, a flowchart of detailed operation of surge bin (200) installed in a paddy processing plant is disclosed, in accordance with an embodiment of a present subject matter. The steps for paddy processing with the help of the system (100) are illustrated as below. At step 201 the automation starts with a start button switched on. Further, at step 202 surge bin 1 may be opened and filling may be started. Further, at step 203 the processor may check for two functions, first whether the paddy high level is reached in the first surge bins or not. If the high level is not reached in surge bin one, then it means that there is no paddy in the surge bin one. In this case, at step 204 automatically the program starts to fill paddy in surge bin one/bin feeding by the involvement of pneumatic slide gates (101-a). Further, at step 205 check HL is bin-01. Further, at step 206 close the bin 1 is closed. Furthermore, at step (206) the program checks whether the high level is reached in surge bin-01, there will be two condition set for the process. Condition one may close the feeding and condition two may check for surge bin-02 for high level.

However, at step 203, if the paddy high level is reached in the surge bin one, then at step 207 the processor may check for the high level in the second surge bin. If the second surge bin is full then the feeding is stopped.

At step (208) two conditions are applied. In first condition, if high level reached in both the bins then at step (212) the process is stopped and to start the process once again program may set the reset button. Further, in second condition, if the high level is not reached then at step (209), (210), (211) the same steps as (204), (205), (206) may repeated for surge bin-02. Once the Surge bin high level is reached then at step (212) the process may be stopped and finally at step (213) for next batch of paddy reset button is pressed and the execution is redirected to step 201.

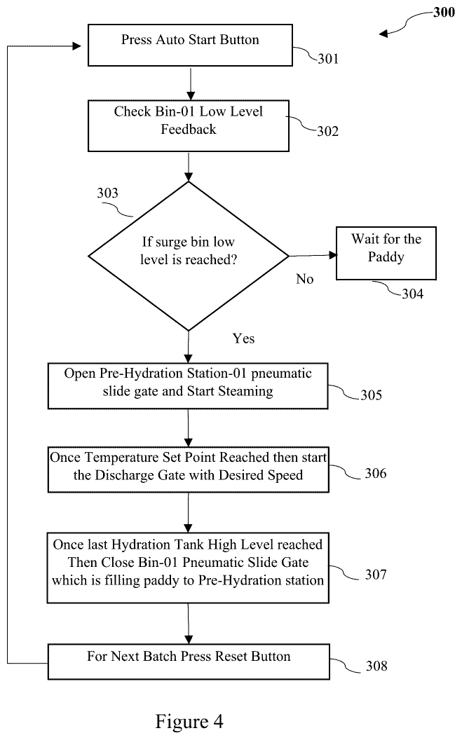

Now referring to FIG. 4, a flowchart of detailed operation of pre-hydration station (300) installed in a paddy processing plant is disclosed, in accordance with an embodiment of a present subject matter. At step (301), the program starts with the initial manual start button is turned on of the pre-hydration station. Further, at step (302), The first condition checks for the surge bin one for low level sensor. Further, at step (303), two conditions may be applicable if the low level is reached or not. Further, at step (304), the first condition may be applied and if the low level is not reached then the surge bin waits for the paddy to be filled. Further, at step (305) the second condition may be applied and if the low level is reached then the pneumatic slide gate (101-a) opens and the paddy enters the pre-hydration station and the steaming process starts thereafter. Further, at step (306) the program waits for the attainment of temperature set point. Once the temperature of the pre-hydration station set point reached then program opens the rotary discharge system (101-h) to discharge the paddy with pre-determined and desired speed. This process continues till the last hydration tank is completely filled. Further, at step (307) once the last hydration tank high level reached then surge bin which is filling pre hydration station is closed. Finally, at step (308) reset button is pressed till the next batch of paddy arrives.

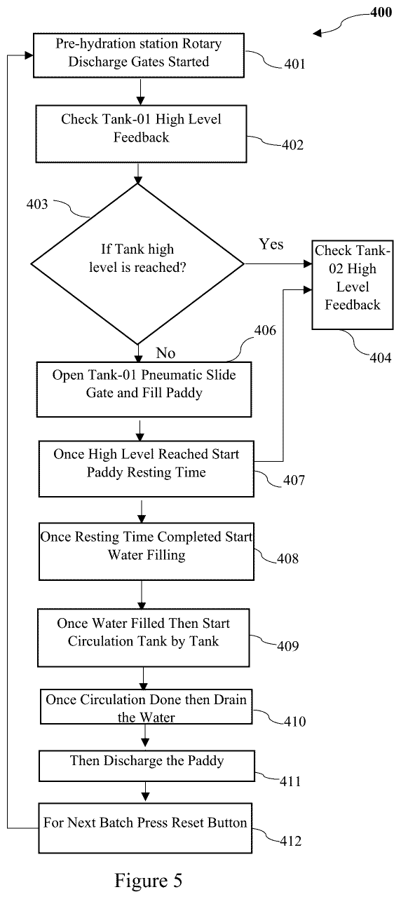

Now referring to FIG. 5, a flowchart of detailed operation hydration station (400) installed in a paddy processing plant is disclosed, in accordance with an embodiment of a present subject matter. The paddy hydration process may be carried out in two ways, paddy first process or the water first process. The following process discloses the paddy first process. At step (401) the processing flow of hydration tank starts once the discharge of paddy takes place form the pre-hydration station which is regulated by the rotary discharge system (101-h). Further, at step (402) the high level sensor (101-b) may check the paddy level in the hydration tank. Further, at step (403) two conditioned are checked in the first condition, the system checks the high level sensor (101-b) in the hydration tank one, if the high level is attained in the hydration tank one, then at step (404) the system checks for hydration tank two and may repeat same process hydration tank-04 is full. Once the last hydration tank reaches the high level then the system stops the pneumatic slide gate (101-a) of pre-hydration station. Further, in the second condition, if high level is not reached in the hydration tank-01, then at step (406) pneumatic slide gates (101-a) of hydration tank-01 of pre-hydration station may be opened. Further, once the process starts in hydration tank-01 the system may check for high level in hydration tank-02 using the high level sensor (101-b). This process may continue till all the hydration tanks reach the high level. Further, at step (407) paddy resting time is started. Further, at step (408) Once the desired resting time reached, start water filling to hydration tank one. Further, at step (409) once the water filling is done in all the four tanks. Start water recirculation tank by tank sequentially. Further, at step (410) once the hydration process is completed then water may be discharged. Further, at step (411) the paddy may be discharged by manual method. This same step repeats in hydration tank-01 to hydration tank-04. Finally, at step (412) once again restart button may be to start the hydration process of the next batch.

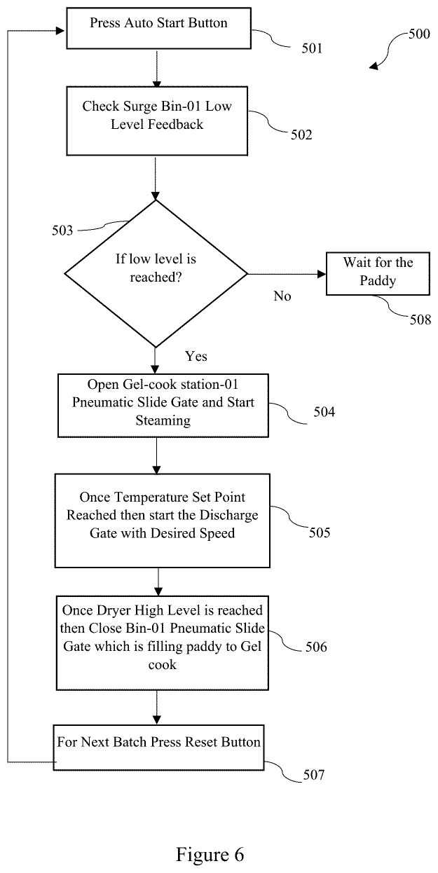

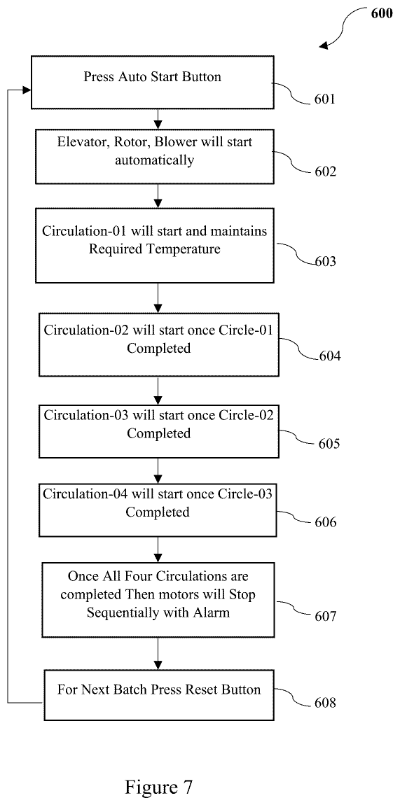

Now referring to FIG. 6, a flowchart of detailed operation of gel cook station (500) installed in a paddy processing plant is disclosed, in accordance with an embodiment of a present subject matter. At step (501) auto start button is pressed. Further, at step (502) the program checks for the low level sensor (101-c) of the surge bin-01. Further, at step (503) two conditions are applied. In the first condition if the low level is not reached then system waits at step (508) for the paddy to be filled. If the low level is reached it activates the gel cook one pneumatic slide gate (101-a) to discharge the paddy to the gel cook station. Further, at step (504) once the pneumatic slide gate (101-a) starts paddy discharge simultaneously the steaming process is initiated in the gel cooker. This process may be a continues or online process. Further, at step (505) once the temperature set point is reached in the gel cooker then the program is initiated to discharge the paddy through the rotary discharge system (101-h). The discharge of the paddy may be set according to the required product quality, paddy variety and the processing condition. This process may continue till the entire batch of paddy is discharged. Further, at step (506) once the high level in drying station is reached then the program may initiated to close the surge bin-01 by closing pneumatic slide gate (101-a) which regulates the paddy to the gel cook. Finally, at step (507) once this process is completed then the operation of the gel cook process may be reinitiated by pressing the restart button. Now referring to FIG. 7, a flowchart of detailed operation of the drying station (600) installed in a paddy processing plant is disclosed, in accordance with an embodiment of a present subject matter. At step (601) press auto start button. Further, the program starts at step (602) the simultaneous operation of rotor, blower and the elevator. Further, at step (603) the program may start the circulation-01 with the attainment of desired temperature in the drying station. Further, at steps (604), (605) and (606) the circulation-02 is followed by the completion of circulation-01 and may continue till the completion of circulation-04. Further, at step (607), once all the circulations are completed the motor may be stopped and an alarm may be generated to mark the completion of the drying process. Further, at step (608), once the drying process is completed the drying of the next batch may be initiated by the reset button.

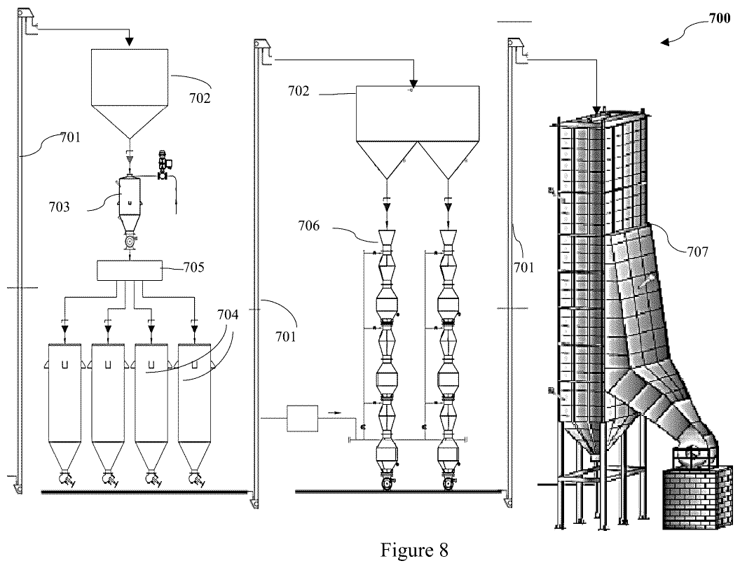

Now referring to FIG. 8, illustrates a parboiling system (700) installed in a paddy processing plant is disclosed, in accordance with an embodiment of a present subject matter. The Parboiling system (700) comprises the feeding elevator, the surge bin, the pre-hydration station, the hydration station, the gel cook station and the drying station. Further The system (100) as disclosed above may be enabled control and monitoring of the parboiling system. The individual stages of the parboiling system are explained in detail as follows,

Further, in one embodiment of the parboiling system (700), the feeding elevator provided. The paddy processing starts with the feeding elevator. Further, the feeding elevator carries the cleaned and uniformly dried raw or new paddy to the surge bin. The feeding elevator may comprise of the pneumatic diverter (101-d), the speed monitor (101-f), the energy meter (101-g) and the belt slack monitor which are controlled by the local control unit (102).

Further, in one embodiment of the parboiling system (700), the surge bin may be provided. The surge bin may be a buffer bin to feed paddy to the pre hydration tank/final steaming tanks (gel cookers) in an online or continuous mode. The surge bin receives the raw paddy from the pre cleaning unit/hydration tanks through bucket elevators. The surge bins are equipped with high the level sensor (101-b) and the low level sensor (101-c) which are involved in regulating the amount of incoming paddy. The outlet of the surge bin i.e., bottom hopper is mounted with a manual and the pneumatic slide gate 101-a. The pneumatic slide gate (101-a) is operated by the signals from the local control unit (102). It is involved in opening and or as cut off valves or as emergency shut off gates to stop material surges.

Further, in one embodiment of the parboiling system (700), the pre-hydration station may be provided. Further, the pre-hydration station may involve pre-conditioning of paddy before hydration or soaking process. The pre-hydration station may receive the paddy from the surge bin through the pneumatic slide gate (101-a) controlled by the local control unit (102). Further, pre-hydration tank constitutes a dynamic steaming chamber which may comprise of a branched sparger system for steaming of paddy. Further, the pre-hydration tank operates in a continues or online mode involving fully automated controlled system. Further the steaming chamber is equipped with the RTD temperature detector (101-l) which ensures the required set temperature to be provided to the grain. This plays a crucial role in regulating the rotary discharge system (101-h) for sample discharge which is controlled by the local control unit (102). The steam provided to the pre-hydration station is regulated by various control systems and sensors which include the pressure transmitter (101-m), the pressure regulating valve (101-n) and the steam flow meter (101-o). These control systems essentially reduce the process time, increase the steam efficiency & bring about uniform steaming of paddy. Once the paddy reaches the required thermal treatment equilibrium the rotary discharge system (101-h) are activated for discharge of paddy to the next processing stages which is controlled by the local control unit (102).

Further, in one embodiment of the parboiling system (700), the hydration station may be provided. The paddy hydration process is carried out in two ways mainly, paddy first process or the water first process. The hydration is a crucial step in parboiling. Hence, hydration process involves various mechanisms such as an auto hydro feeding mechanism or an auto hydro circulation mechanism or an auto static hydrothermal temperature maintaining system or an auto hydro draining system or an auto or manual discharge mechanism. Further the presently disclosed hydration process achieves uniform and maximum starch gelatinization. Further, the parameters of uniform and maximum starch gelatinization may be achieved by the involvement of various water instruments, sensors and systems which may include the water flow meter (101-i), the pneumatic butterfly valve (101-j), the RTD temperature detector (101-l) and the float level switch (101-k). The specific temperature maintained during hydration process is regulated by the steam and the water recirculation process. The key components involved in the regulation, control and process monitoring of steam instruments include the RTD temperature detector (101-l), the pressure transmitter (101-m), the pressure regulating valve (101-n) and the steam flow meter (101-o). The RTD temperature detector (101-l), the pneumatic butterfly valve (101-j) and the float level switch (101-k) also regulates and maintains the desired water temperature required for the process in the hot water tank. Further, advanced automation ensures attainment of uniform color across the grain resulting in zero process rejections. Further, once the paddy attains the desired characteristics as per the customer requirements at a pre-determined time, the rotary discharge system (101-h) open, and the paddy is discharged and further continued for final processing by the help of belt conveyor.

Further, in one embodiment of the parboiling system (700), the gel cook station. Further, the gel cook station constitute dynamic steaming and resting chambers together forming a vertical channel which may comprise six cylindrical chambers arranged one below the other. This unit operates in a continues mode for final steaming of paddy after hydration process. The hydrated paddy to the final steaming gel cook station comes from the surge bin which is received from the hydration tanks. The main component involved in the efficient steaming of gel cook is the branched sparger system. The efficiency of the final steaming unit or the gel cook is achieved by the involvement of automation by the instruments and sensors comprise of the RTD temperature detector (101-l), the pressure transmitter (101-m), the pressure regulating valve (101-n) and the steam flow meter (101-o). Once the required set temperature is achieved the rotary discharge system (101-h) discharges the paddy to the drying station which may be operated by the local control unit (102).

Further, in one embodiment of the parboiling system (700), the drying station may be provided. The paddy after post steaming or gel cook is loaded to the drying station through the feeding elevator. The processed paddy is dried under regulated condition and is controlled and monitored by the local control unit (102). The various instruments or sensors which regulate the drying process include high level sensor (101-b) and low-level sensor (101-c), paddy moisture meter (101-e), RTD temperature detector (101-l), pressure transmitter (101-m), pressure regulating valve (101-n) and steam flow meter (101-o).

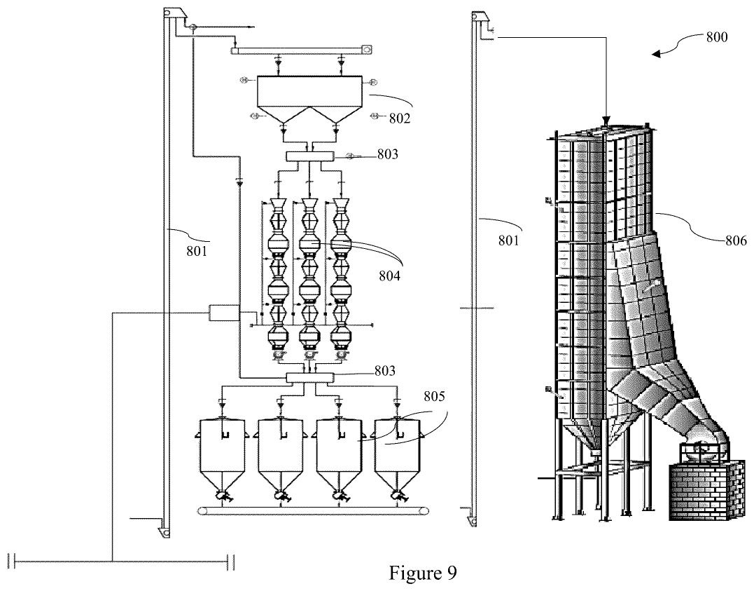

Now referring to FIG. 9, illustrates a super-aging system (800) installed in a paddy processing plant is disclosed, in accordance with an embodiment of a present subject matter.

The super ageing system (800) may transform the harvested or new paddy into nearly one year old paddy. The process involves ageing of rice by thermal treatment and thermal seasoning (precise combination of steam and temperature) which ensures consistent quality and renders the rice with desired cooking qualities comparable to naturally aged rice/approximately one year old rice. The super ageing technology involves multi-stage processing of input paddy with the components in sequence which includes the feeding elevator, the surge bin, the gel cook station, the distribution box, thermal seasoning tanks and the drying station. The various instruments or sensors which regulate the super ageing technology are similar to those detailed for the parboiling process. However, the there is a difference in the process parameters.

In one embodiment of the super ageing system (800), the feeding elevator may be provided. Further, the feeding elevators may comprise a series of bucket elevators which may carry the cleaned and uniformly dried raw or new paddy to the surge bin. The feeding elevator may comprise the pneumatic diverter (101-d), the speed monitor (101-f), the energy meter (101-g) and the belt slack monitor which may be controlled by the local control unit (102).

Further, in one embodiment of the super ageing system (800), the surge bin may be provided. Further, the surge bin may act as a buffer bin to feed paddy to the super ageing station in an online or continuous mode. The surge bin may receive the raw paddy through the feeding elevators. The surge bins may be equipped with the high level sensor (101-b) and low level sensor (101-c) which are involved in regulating the amount of incoming paddy. Further, the signals from these sensors may be linked with the local control unit (102) for maintaining the paddy for continuous process. The outlet of the surge bin i.e. bottom hopper may be mounted with the manual and the pneumatic slide gate (101-a). The pneumatic slide gate (101-a) may be operated by the signals from the local control unit (102).

In another embodiment the gel cook station may be provided. The gel cook station may comprise dynamic steaming and resting chambers together forming a vertical channel which may comprise six cylindrical chambers arranged one below the other. the gel cook station may operate in a continues mode for final steaming of paddy. Further, for efficient steaming of gel cook is the gel cook station may comprise a branched sparger system. Further, the efficiency of the final steaming unit or the gel cook is achieved by the involvement of automation by the instruments and sensors which may comprise of the RTD temperature detector (101-l), the pressure transmitter (101-m), the pressure regulating valve (101-n) and the steam flow meter (101-o). Once the required set temperature is achieved the rotary discharge system (101-h) discharge the paddy to the thermal seasoning tanks through the distribution box controlled and coordinated by the local control unit (102).

Further, in one embodiment of the super ageing system (800), the distribution box may be provided. The distribution box may sequentially distribute the paddy with equilibrium ageing temperature to the four thermal seasoning tanks by the help of pneumatic slide gates (101-a). The distribution box is connected and followed by the thermal seasoning tanks at the base.

Further, in another embodiment of the super ageing system (800), the thermal seasoning tanks may be provided. Further, the thermal seasoning tanks may be made up of stainless steel with a top cover assembly and an outlet neck assembly at the base. The paddy may be left to a resting process called the thermal seasoning time to attain the desired color. This whole process ensures the ageing of paddy to the best of the cooking characters similar to the naturally aged rice. Once the paddy attains the desired characteristics of ageing at a pre-determined time, the rotary discharge system (101-h) may open and the paddy may be sent to the drying process for the completion of super ageing process.

Further, in another embodiment of the super ageing system (800), the drying station may be provided. The paddy after post steaming or gel cook is loaded to the drying station through the feeding elevator. The processed paddy is dried under regulated condition and is controlled and monitored by the local control unit (102). The various instruments or sensors which regulate the drying process include the high level sensor (101-b) and the low level sensor (101-c), the paddy moisture meter (101-e), the RTD temperature detector (101-l), the pressure transmitter (101-m), the pressure regulating valve (101-n) and the steam flow meter (101-o).

The embodiments illustrated above, especially related to the system for processing of paddy provide following advantages:
The system for processing of paddy is fully automated minimizing human intervention.
The system for processing of paddy is online or continuous process involving fully automated controlled system, which is essential for reducing the process time, steam efficiency & to obtain uniform steaming of paddy.
This reduces the human interference and brings about consistent and quality results of the output paddy.

Various modifications to the embodiment will be readily apparent to those skilled in the art and the generic principles herein may be applied to other embodiments.

However, one of ordinary skill in the art will readily recognize that the present disclosure is not intended to be limited to the embodiments illustrated but is to be accorded the widest scope consistent with the principles and features described herein.

The foregoing description shall be interpreted as illustrative and not in any limiting sense. A person of ordinary skill in the art would understand that certain modifications could come within the scope of this disclosure.

The embodiments, examples and alternatives of the preceding paragraphs or the description and drawings, including any of their various aspects or respective individual features, may be taken independently or in any combination. Features described in connection with one embodiment are applicable to all embodiments, unless such features are incompatible.

1. A system (100) for processing of paddy, the system comprises:
a set of processing stations;
a set of field instruments (101), wherein one or more field instruments, from the set of field instruments is configured to monitor a processing station from the set of processing stations, wherein the set of field instruments (101) are configured to collect data from the set of processing stations; and
a local control unit (102) comprising:
a processor coupled to a memory, wherein the processor is configured to execute a set of instructions stored in the memory for:
receiving (102-a) the data from the set of field instruments (101),
comparing (102-b) the data with pre-determined thresholds,
generating (102-c) set of commands corresponding to at least one target field instrument, from the set of field instruments (101), based the comparison,
identifying (102-d) at least one target processing station, from the set of processing stations, corresponding to the at least one target field instrument, and
transmitting (102-e) the set of commands to the at least one target processing station, thereby controlling the set of processing stations for paddy processing.

2. The system (100) as claimed in claim 1, wherein the local control unit (102) comprises Input/output cards (I/O cards) configured to receive data and transmit instructions from the processor to the at least one field instruments from the set of field instruments (101).

3. The system (100) as claimed in claim 1 further comprises a cloud server (103), wherein the cloud server (103) is configured to facilitate communication between the local control unit (102) and store data related to the paddy processing.

4. The system (100) as claimed in claim 2 further comprises a remote control devices (104) communicatively coupled with the cloud server (103), wherein the remote control devices (104) are configured to monitor and visualize the paddy processing from remote location.

5. The system (100) as claimed in claim 1 further comprises Industrial internet of things (IIoT) and it is linked to user.

6. The system (100) for paddy processing as claimed in claim 1, wherein the processing of paddy comprises a parboiling process and a super-aging process.

7. The system (100) as claimed in claim 1, wherein the set of processing stations comprises a feeding elevator, a surge bin, a pre-hydration station, a hydration station, a gel cook station, a distribution box, thermal seasoning tanks and a drying station.

8. The system (100) as claimed in claim 1, wherein the set of field instruments (101) comprises a pneumatic slide gate (101-a), a high level sensor (101-b), a low level sensor (101-c), a pneumatic diverter (101-d), a paddy moisture meter (101-e), a speed monitor (101-f), an energy meter (101-g), a rotary discharge system (101-h), a water flow meter (101-i), a pneumatic butterfly valve (101j), a float level switch (101-k), a RTD temperature detector (101-l), a pressure transmitter (101-m), a pressure regulating valve (101-n), a steam flow meter (101-o) and a belt slack monitor.

9. The system (100) as claimed in claim 6, wherein the parboiling process comprises: the feeding elevator, the surge bin, the pre-hydration station, the hydration station, the gel cook station and the drying station.

10. The system (100) as claimed in claim 6, wherein the super-aging process comprises: the feeding elevator, the surge bin, the gel cook station, the distribution box, the thermal seasoning tanks and the drying station.

11. The system (100) as claimed in claim 7, wherein the feeding elevator, from the set of processing stations, comprises the set of field instruments (101) including the pneumatic diverter (101-d), the speed monitor (101-f), the energy meter (101-g), the belt slack monitor.

12. The system (100) as claimed in claim 7, wherein the surge bin, from the set of processing stations, comprises the set of field instruments (101) including the high level sensor (101-b), the low level sensor (101-c), the pneumatic slide gate (101-a) configured to maintain the paddy for continuous process and regulating the amount of incoming paddy.

13. The system (100) as claimed in claim 7, wherein the pre-hydration station comprises the set of field instruments (101) including the pneumatic slide gate (101-a), the RTD temperature detector (101-l), the rotary discharge system (101-h), the pressure transmitter (101-m), the pressure regulating valve (101-n), the steam flow meter (101-o) and the rotary discharge system (101-h) configured to monitor and regulate the pre-hydration process and pre-condition the paddy before hydration or soaking process.

14. The system (100) as claimed in claim 7, wherein the hydration station, from the set of processing stations, comprises the set of field instruments (101) including the water flow meter (101-i), the pneumatic butterfly valve (101-j), the float level switch (101-k), the RTD temperature detector (101-l), the pressure transmitter (101-m), the pressure regulating valve (101-n), the steam flow meter (101-o), and the rotary discharge system (101-h) configured to monitor and regulate the hydration process and achieve uniform and maximum starch gelatinization of rice grain.

15. The system (100) as claimed in claim 7, wherein the gel cook station, from the set of processing stations, comprises the field instruments (101) including the RTD temperature detector (101-l), the pressure transmitter (101-m), the pressure regulating valve (101-n) and the steam flow meter (101-o) configured to monitor and regulate gel the gel-cooking process and the perform dynamic steaming and resting of paddy.

16. The system (100) as claimed in claim 7, wherein the drying station, from the set of processing stations, comprises the set of field instruments (101) including: the high level sensor (101-b) the low level sensor (101-c) the paddy moisture meter (101-e), the RTD temperature detector (101-l), the pressure transmitter (101-m), the pressure regulating valve (101-n), and the steam flow meter (101-o) configured to monitor and regulate the drying process and dry paddy under regulated conditions.

17. The system (100) as claimed in claim 7, wherein the distribution box, from the set of processing stations, comprises the set of field instruments (101) including the pneumatic slide gate (101-a) configured to sequentially distribute the paddy with equilibrium ageing temperature to the four thermal seasoning tanks.

18. The system (100) as claimed in claim 7, wherein the thermal seasoning tanks, from the set of processing stations, comprises the set of field instruments (101) including the rotary discharge system (101-h) configured to regulate resting process by controlling thermal seasoning time to attain the desired color of rice grain.
